(19) United States
(12) Patent Application Publication
(10) Pub. No.: US 2025/0010548 A1
(43) Pub. Date: Jan. 9, 2025

(54) SUCTION DEVICE FOR SUCKING UP PROCESS GAS WITH A STATIONARY GAS-CONVEYING CHANNEL AND DEVICE FOR PRODUCING THREE-DIMENSIONAL OBJECTS COMPRISING SUCH A SUCTION DEVICE

(71) Applicant: TRUMPF Laser- und Systemtechnik GmbH, Ditzingen (DE)

(72) Inventor: Florian Schaede, Stuttgart (DE)

(21) Appl. No.: 18/892,597

(22) Filed: Sep. 23, 2024

Related U.S. Application Data
(63) Continuation of application No. PCT/EP2023/056344, filed on Mar. 13, 2023.

(30) Foreign Application Priority Data
Apr. 5, 2022 (DE) 10 2022 108 136.2

(51) Int. Cl. B29C 64/371; B22F 10/28; B22F 12/70; B29C 64/153; B33Y 30/00; B33Y 40/00

(52) U.S. Cl. CPC B29C 64/371; B22F 10/28; B22F 12/70; B29C 64/153; B33Y 30/00; B33Y 40/00

(57) ABSTRACT

A suction device for sucking up process gas from a process chamber of a device for producing three-dimensional objects by selective solidification of a build-up material applied in layers by using a beam acting on the build-up material is provided. The suction device includes a translationally movable suction module, a gas-conveying channel arranged in a stationary manner and having an elongated slot, and a connector connected to the suction module and movable in the elongated slot of the gas-conveying channel. The connector fluidically connects the suction module to the gas-conveying channel.

### CROSS REFERENCE TO RELATED APPLICATIONS

This application is a continuation of International Application No. PCT/EP2023/056344 (WO 2023/194043 A1), filed on Mar. 13, 2023, and claims benefit to German Patent Application No. DE 10 2022 108 136.2, filed on Apr. 5, 2022. The aforementioned applications are hereby incorporated by reference herein.

### FIELD

Embodiments of the present invention relate to a suction device for sucking up process gas from a process chamber of a device for producing three-dimensional objects by selective solidification of a build-up material applied in layers by means of a beam acting on the build-up material. Embodiments of the present invention also relate to a device for producing three-dimensional objects by selective solidification of a build-up material applied in layers by means of a beam acting on the build-up material.

Mobile suction modules are necessary, for example, for parallel coating and exposure in devices for producing three-dimensional objects by selective solidification of a build-up material applied in layers by means of a beam acting on the build-up material. They can be connected to a stationary part of a gas circulation system using flexible hoses. Depending on the travel paths of the suction module, the length and undulation of the hose lines generate pressure losses, which reduce the performance of the circulation system.

### BACKGROUND

DE 10 2017 210 718 A1 discloses a suction bar for a protective gas flow in which an outlet opening can be moved parallel to a powder bed.

DE 10 2014 214 943 A1 shows a suction tube which is operatively connected to a suction device in a stationary position outside a component platform.

### SUMMARY

Embodiments of the present invention provide a suction device for sucking up process gas from a process chamber of a device for producing three-dimensional objects by selective solidification of a build-up material applied in layers by using a beam acting on the build-up material. The suction device includes a translationally movable suction module, a gas-conveying channel arranged in a stationary manner and having an elongated slot, and a connector connected to the suction module and movable in the elongated slot of the gas-conveying channel. The connector fluidically connects the suction module to the gas-conveying channel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of a device for producing three-dimensional objects by selective solidification of a build-up material applied in layers according to some embodiments;

FIG. 2 shows a schematic view of a device for producing three-dimensional objects, showing details of the suction device according to some embodiments;

FIG. 3 shows a perspective view of a suction device according to some embodiments;

FIG. 4 shows a detailed view of the gas-conveying channel with an eccentric suction detection system according to some embodiments;

FIG. 5 shows a schematic plan view of the suction device according to some embodiments; and

FIG. 6 shows a perspective view of the suction device to illustrate the lifting of sealing lips, according to some embodiments.

### DETAILED DESCRIPTION

Embodiments of the present invention provide a suction device for a device for producing three-dimensional objects by selective solidification of a build-up material applied in layers by means of a beam acting on the build-up material, by means of which the performance of a gas circulation system can be improved.

According to embodiments of the invention, a suction device for sucking up process gas from a process chamber of a device for producing three-dimensional objects by selective solidification of a build-up material applied in layers by means of a beam acting on the build-up material, comprising
a translationally movable suction module;
a gas-conveying channel which is arranged in a stationary manner and has an elongated slot;
a connection module which is connected to the suction module, is movable in the elongated slot of the gas-conveying channel and which fluidically connects the suction module to the gas-conveying channel.

According to embodiments of the invention, it is therefore possible to use a stationary gas-conveying channel instead of flexible hoses which are guided in energy chains, in which channel a translationally displaceable connection module is arranged, which is connected to the suction module. Disadvantages associated with flexible hoses can thus be avoided. This results in lower pressure losses in the discharge tract. This leads to a significant increase in the performance of the entire gas circuit. Bulky energy chains for guiding hoses can be avoided. Especially in the case of swirl-assisted suction methods, flexible hoses with an undulating structure have a very adverse effect on pressure losses.

It is preferred if the gas-conveying channel in the region of its elongated slot has sealing lips, between which the connection module is arranged. This allows the gas-conveying channel to be sealed from the environment via elongated sealing lips that are compressed under negative pressure. Pressure losses can thus be avoided. The connection module has the task of enabling a closed suction line between a suction/coating module during coating/exposure.

The sealing lips can be directed away from the gas-conveying channel towards the exhaust module. This ensures that the sealing lips are pressed against the connection module by a negative pressure, thus providing additional sealing.

The sealing lips can be made of a heat-resistant material, in particular silicone. This can prevent the sealing lips from aging prematurely due to heat exposure.

The connection module can move in a direction parallel to the direction of the elongated slot of the gas-conveying channel towards its ends. On the one hand, this ensures good sealing between the connection module and the gas-conveying channel. On the other hand, the connection module can easily expand the sealing lips during a translational movement.

The gas-conveying channel can have a smooth inner wall. A smooth inner wall prevents turbulence and ensures reliable gas discharge.

The gas-conveying channel can be oriented parallel to a build-up platform of the process chamber.

Further advantages arise if the connection module has an axial separating unit. The axial separating unit can separate particles from the process gas sucked in through the suction module. The axial separating unit can be provided with a chute to separate the particles from the process gas stream. The axial separating unit can have a conical separator. Owing to the swirl generated in the suction module, a centrifugal force acts on the particles so that the particles drifting outwards can be separated from the process gas stream by the conical separator.

At least two suction modules can be connected to the connection module. It is conceivable to provide a plurality of connection modules, with one or two or more suction modules being connectable to each connection module.

The connection module can have an eccentric gas stream detection system. This allows the swirl intensity to be reduced when transferring the process gas stream into the gas-conveying channel. In particular, an eccentric gas stream detection system in a swirl tube can ensure de-swirling.

The connection module can have a gas stream merging system through which process gas streams emerging from the suction modules can be fed together to the gas-conveying channel. The process gas streams, which each have a swirl, can be merged in the gas stream merging system, and a type of de-swirl takes place in a common outlet opening so that a unidirectional process gas flow subsequently leaves the connection module into the gas-conveying channel. This can subsequently result in reduced pressure loss in the suction line.

A guide for the connection module can be provided. For example, a roller guide or a guide on rails can be used.

A drive can be provided to move the connection module relative to the gas-conveying channel. This could be, for example, a linear drive. It is conceivable for the connection module to be movable by the suction module. Preferably, however, a drive is provided to drive the connection module separately. The connection module can be driven parallel to the suction module.

In a further embodiment of the invention, at least one actuator can be provided by which a sealing lip can be locally raised or lowered so that an opening to the interior of the gas-conveying channel is created. Actuators can also be arranged on opposite sides so that an upper and lower sealing lip are pulled apart by the actuators, creating an opening. Thus, the suction device according to embodiments of the invention can be used during an inerting process to remove oxygen nests, in particular local oxygen nests.

The connection module can be detachably connected to the suction module. This means that even without actuators or local lifting of the sealing lips, oxygen nests can be extracted via the connection module. In particular, dead zones of the process chamber can be extracted, e.g., for inerting.

Embodiments of the invention also provide a device for producing three-dimensional objects by selective solidification of a build-up material applied in layers by means of a beam acting on the build-up material, comprising
at least one beam guidance source for generating a beam;
at least one beam guiding element for guiding and directing the beam onto the build-up material to be solidified,
at least one gas supply apparatus, and
a suction device according to embodiments of the invention.

Embodiments of the invention are described and explained in more detail below by means of the examples illustrated in the drawings. The features that can be derived from the description and the drawings can be used individually by themselves or as a plurality in any combination according to embodiments of the invention.

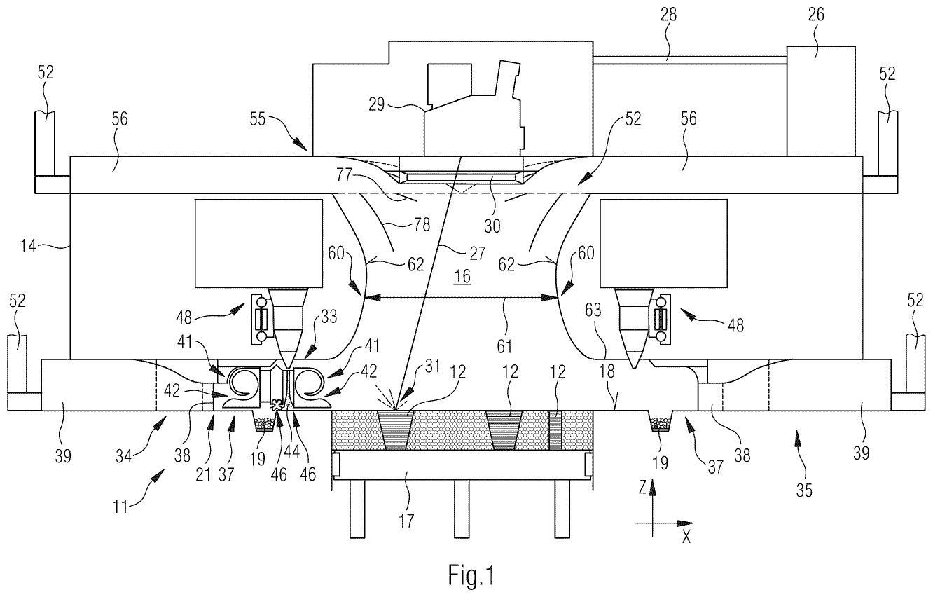

FIG. 1 shows a schematic side view of a device 11 for producing three-dimensional objects 12 by selective solidification of a build-up material applied in layers. These devices 11 are also referred to as 3D printing systems, selective laser sintering machines, selective laser melting machines, or the like. The device 11 comprises a housing 14, in which a process chamber 16 is provided. The process chamber 16 is closed towards the outside. It can be accessible via a door, which is not shown in more detail, or a safety closure.

A build-up platform 17, on which at least one three-dimensional object 12 is created in layers, is provided in the process chamber 16. The size of the build-up platform 17 determines a build-up field for the production of the three-dimensional objects 12. The build-up platform 12 can be displaced vertically or in the Z direction. Provided adjacent to the build-up platform 17 are overflow containers 19 or collection containers, in which non-required or unattached build-up material is gathered. A process assistance apparatus 21 is arranged in the process chamber 16 above the build-up platform 17. This process assistance apparatus 21 can be displaced at least partially in the X direction.

A radiation source 26, which generates a beam 27, in particular a laser beam, is assigned to the process chamber 16 or attached to the process chamber 16. This laser beam is guided along a beam guide 28 and is deflected and directed onto the build-up platform 17 by a controllable beam guiding element 29. In the process, the beam 27 enters the process chamber 16 through a beam inlet opening 30. The build-up material applied to the build-up platform 17 can be solidified at the impingement point 31 of the beam 27.

The process assistance apparatus 21 comprises a central module 33 and an external module 34, 35 assigned in each case to the central module 33. The external modules 34, 35 can be provided fixed in relation to a process chamber floor 18. The central module 33 is controlled displaceably between a left and right end position 36, 37. In the view according to FIG. 1, the central module 33 is positioned in the left end position 36. The external modules 34, 35 comprise an outlet nozzle 38, which is attached in a feed channel 39. The outlet nozzles 38 preferably have vertically oriented guide surfaces. In addition, the outlet nozzles 38 are designed to taper in the direction of emergence. This makes it possible to homogenize and stabilize a primary gas stream fed into the process chamber 16.

The central module 33 comprises two suction modules 41, which each have an oppositely oriented intake opening 42. A storage container 44 for receiving build-up material is provided between the suction modules 41. This storage container 44 has at least one opening or a discharge slot directed towards the process chamber floor 18, with the result that a layer of build-up material can be discharged by the central module 33 when it is moving over the build-up platform 17. A coating apparatus 46 is preferably provided between two storage containers 44 that are arranged adjacent to the suction modules 41. Preferably, the storage container 44 which runs ahead in the direction of movement of the central module 33 is filled with build-up material. The coating apparatus 46 comes next. In particular, the coating apparatus 46 comprises at least one coater lip.

A metering device 48 can be arranged to be displaceable along a Y axis so that the storage container 44 can be filled evenly across the width of the central module 33.

The overflow container 19 is likewise assigned to the right and the left end position 36, 37, with the result that stripped build-up material can be removed into the overflow container 19 by the coating apparatus 46 of the central module 33 when the end position 36, 37 is assumed.

Each external module 33 is connected to a supply line 52. The supply line 52 is loaded with a primary gas by a pump or primary gas source, which is not shown in more detail, such that a primary gas flow can be discharged into the process chamber 16 by the external modules 34.

A gas supply apparatus 55 for a secondary gas flow into the process chamber 16 is provided above the process chamber 16. This gas supply apparatus 55 comprises two mutually opposite feed channels 56, which are positioned adjoining the beam inlet opening 30. The secondary gas flows into the process chamber 16 and is fed from above onto the build-up platform 17 through at least one feed opening 57, which is assigned to or surrounds the beam inlet opening 30.

The process chamber 16 has lateral wall portions 60, which delimit the length of the process chamber 16. These wall portions 60 comprise flow surfaces 62, which extend towards the build-up platform 17 and constrict a cross-sectional area of the process chamber 16. A distance 61 is provided which corresponds to the length of the build-up platform 17, which extends in the longitudinal direction, or is preferably smaller. The flow surface 62 widens from the smallest distance 61. The wall portions 60 merge into a horizontal boundary surface 63. This boundary surface 63 preferably runs parallel to the process chamber floor 18 and is provided at a distance from the process chamber floor 18, such that the process assistance apparatus 21 can be positioned between the boundary surface 63 and the process chamber floor 18.

Secondary gas is supplied to each feed channel 56 of the feed apparatus 55 by a secondary gas source, not shown in more detail, via a supply line 52.

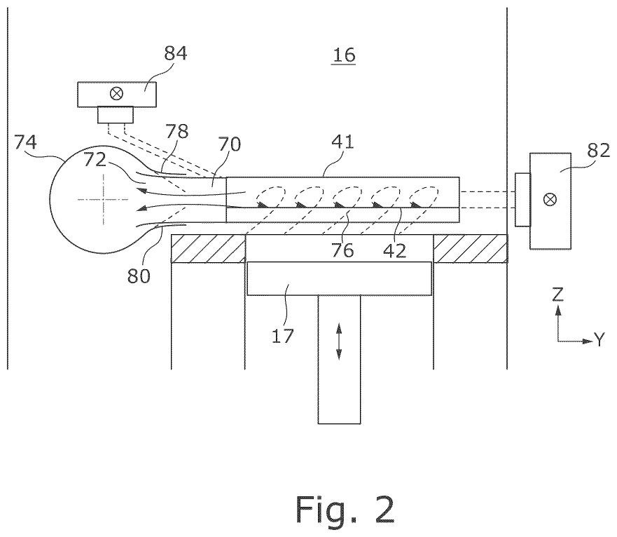

FIG. 2 shows the arrangement according to FIG. 1 in a schematic representation in a direction of view in the X direction. The suction module 41 with its intake opening 42 is connected to a connection module 70 which is translationally movable in an elongated slot 72 of a gas-conveying channel 74. In particular, the connection module 70 is movable together with the suction module 41. The suction module 41 is guided on linear guides 82, 84.

Process gas, which is caused to flow in a swirling manner when sucked in through the intake opening 42, as indicated by the arrows 76, is extracted through the connection module 70 into the gas-conveying channel 74, which is arranged in a stationary manner, i.e., fixed. The extracted gas is transported away through the gas-conveying channel 74. The gas-conveying channel 74 has a smooth inner surface in order to impede the flow of the extracted gases as little as possible.

The connection module 70 is sealed against the gas-conveying channel 74 by sealing lips 78, 80. The sealing lips 78, 80 are formed from a heat-resistant material. In particular, the sealing lips 78, 80 can be formed from silicone.

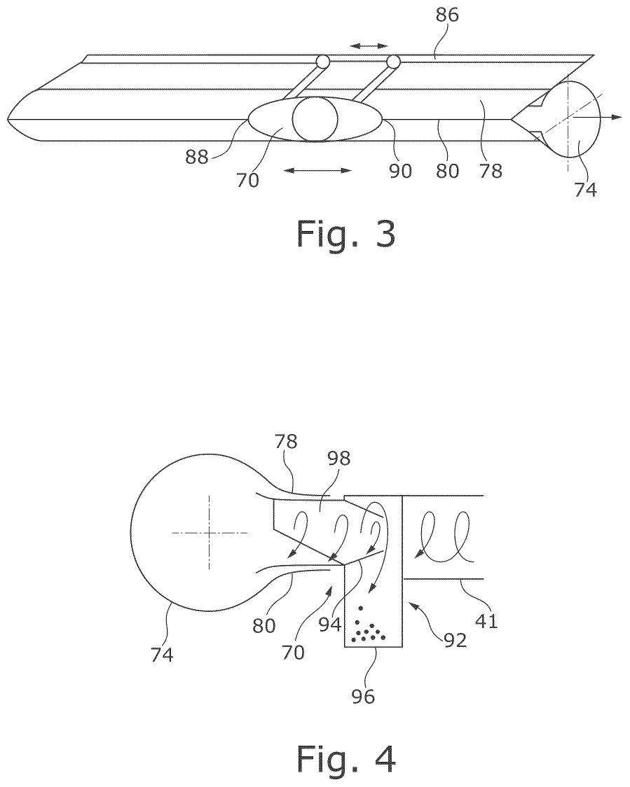

FIG. 3 shows a schematic representation of the gas-conveying channel 74, in the slot 72 of which the connection module 70 is displaceably arranged. In the embodiment shown, the connection module 70 is guided on a roller guide 86. In principle, the connection module 70 can be guided on the gas-conveying channel 74 or on rails.

In FIG. 3 it can be seen that the connection module 70 tapers towards its two ends 88, 90. In particular, it is formed pointed or wedge-like at the ends 88, 90. This makes it possible for the connection module 70 to widen the sealing lips 78, 80 during a movement in the longitudinal direction of the gas-conveying channel 74. The almost lenticular shape of the connection module 70 in cross-section also enables the sealing lips 78, 80 to bear closely against the connection module 70.

The sealing lips 78, 80 are directed away from the gas-conveying channel 74 in the direction of the suction module 41. This allows for good sealing.

From the illustration in FIG. 4 it can be seen that the connection module 70 has an axial separating unit 92. The axial separating unit 92 comprises a preferably conical separator 94. Owing to the swirl of the sucked-in process gas, the axial separating unit 92 separates particles through the separator 94 into a chute 96. An eccentric suction detection system 98 is connected to the separator 94.

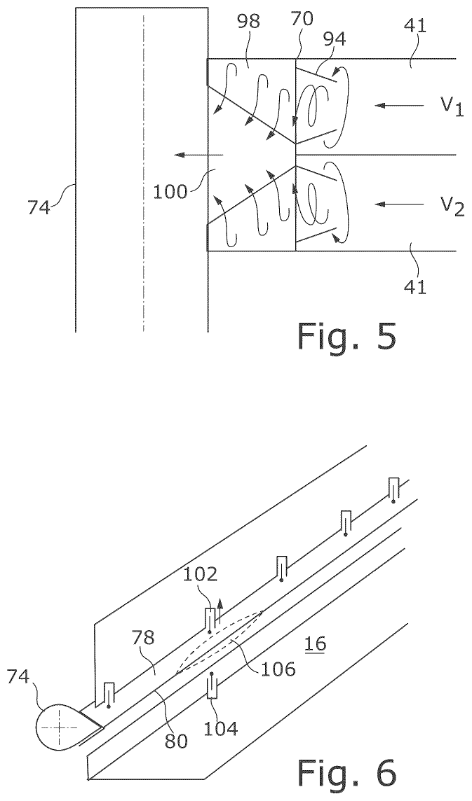

It can be seen from the representation in FIG. 5 that two suction modules 41 can be connected to the connection module 70. The gas streams are combined in a stream merging system 100, where the swirls of the two gas streams cancel each other out so that the gas stream enters the gas-conveying channel 74 substantially swirl-free.

It can be seen in FIG. 6 that actuators 102, 104, in particular a plurality of actuators 102, 104, can be provided at regular intervals along the sealing lips 78, 80. The sealing lips 78, 80 can be raised by the actuators 102, 104 or pulled apart by opposing actuators 102, 104 so that an opening 106 is created. This allows the gas-conveying channel 74 to be used during an inerting process to suck in stationary gas, in particular oxygen nests, along the process chamber via a type of slot suction. This makes it possible to control the gas flow during inerting process in a very controlled manner and to enable reliable flow through the entire process chamber 16. Owing to significantly better detection of oxygen nests, the inerting time and the consumption of inert gas are considerably reduced.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A suction device for sucking up process gas from a process chamber of a device for producing three-dimensional objects by selective solidification of a build-up material applied in layers by using a beam acting on the build-up material, the suction device comprising:
a translationally movable suction module;
a gas-conveying channel arranged in a stationary manner and having an elongated slot; and
a connector connected to the suction module and movable in the elongated slot of the gas-conveying channel, wherein the connector fluidically connects the suction module to the gas-conveying channel.

2. The suction device according to claim 1, wherein the gas-conveying channel comprises sealing lips in a region of the elongated slot, wherein the connector is arranged between the sealing lips.

3. The suction device according to claim 2, wherein the sealing lips are directed away from the gas-conveying channel in a direction of the suction module.

4. The suction device according to claim 2, wherein the sealing lips are made of a heat-resistant material.

5. The suction device according to claim 1, wherein the connector tapers towards an end thereof in a direction parallel to a direction of the elongated slot of the gas-conveying channel.

6. The suction device according to claim 1, wherein the gas-conveying channel has a smooth inner wall.

7. The suction device according to claim 1, wherein the gas-conveying channel is oriented parallel to a build-up platform of the process chamber.

8. The suction device according to claim 1, wherein the connector has at least one axial separating section.

9. The suction device according to claim 1, further comprising a second suction module connected to the connector.

10. The suction device according to claim 1, wherein the connector comprises an eccentric gas stream detection system.

11. The suction device according to claim 9, wherein the connector comprises a gas stream merging system, wherein process gas streams emerging from the suction module and the second suction module are fed through the gas stream merging system together to the gas-conveying channel.

12. The suction device according to claim 1, further comprising a guide for the connector.

13. The suction device according to claim 1, further comprising a drive for moving the connector relative to the gas-conveying channel.

14. The suction device according to claim 1, further comprising at least one actuator for locally raising or lowering a sealing lip of the gas-conveying channel, so that an opening is created around an interior of the gas-conveying channel.

15. The suction device according to claim 1, wherein the connector is detachably connected to the suction module.

16. A device for producing three-dimensional objects by selective solidification of a build-up material applied in layers by using a beam acting on the build-up material, the device comprising:
at least one radiation source for generating the beam,
at least one beam guiding element for guiding and directing the beam onto the build-up material to be solidified,
at least one gas supply apparatus, and
a suction device according to claim 1.
